(19) United States
(12) Patent Application Publication
(10) Pub. No.: US 2011/0151061 A1
(43) Pub. Date: Jun. 23, 2011

(54) FOOD DECORATION

(75) Inventor: Melvin A. Pascall, Columbus, OH (US)

(73) Assignee: THE OHIO STATE UNIVERSITY, Columbus, OH (US)

(21) Appl. No.: 12/978,131

(22) Filed: Dec. 23, 2010

Related U.S. Application Data
(60) Provisional application No. 61/289,813, filed on Dec. 23, 2009.

(51) Int. Cl. A23G 3/54; A23P 1/08; A23P 1/10; A23G 3/42

(52) U.S. Cl. 426/87; 426/383; 426/658; 426/103

(57) ABSTRACT

Various embodiments relate to a method and an arrangement for printing an indicium onto an edible media. In some embodiments, the film is affixed onto a support material. In various embodiments, the film comprises a chitosan polymer. In other embodiments, the film comprises a blend of protein, polysaccharides, and lipids instead of chitosan.

### CROSS-REFERENCE TO RELATED APPLICATIONS

This application claims priority to U.S. Patent Application No. 61/289,813 filed Dec. 23, 2009, which is hereby incorporated by reference in its entirety.

### TECHNICAL FIELD

Embodiments relate to decorative coatings for food. More particularly, embodiments relate to edible films comprising chitosan or chitosan derivatives which are capable of displaying image quality prints when merged to the surface of an edible item.

### BACKGROUND OF THE ART

Professionals and novice cooks continually look for new ways to distinguish their culinary presentations without compromising the taste and quality of the food. Similarly, many companies seek to market themselves in unique ways through the adornment of food. Numerous methods have been developed for decorating food. However, there remains an unmet need for an easy and flexible system for imprinting high quality images and designs on food.

### SUMMARY

Embodiments relate to a method for printing an indicium onto an edible media, comprising: obtaining an edible film comprising a chitosan polymer and or other polysaccharide polymer; printing the indicium onto the film with an edible ink; contacting the film to the edible media. Various embodiments include the step of heating the edible media before or after the contacting step. In some embodiments, the film is affixed onto a support material prior to the contacting step. The method may be used to adorn a wide variety of foods. Additionally, embodiments may be used to decorate beverages. Embodiments may be used to decorate foods with almost any indicia including team logos, corporate trademarks, color photographs, etc.

Embodiments are also directed to a method for preparing an edible film capable of adhering to the surface of a food, comprising; combining chitosan with a water acid solution to form a chitosan solution; mixing the chitosan solution with an emulsifier to form a casting solution; placing the casting solution into a mould; and drying the casting solution until an edible film is formed.

Additional embodiments relate to an arrangement for merging a decoration onto an edible media, comprising an edible film comprising a chitosan polymer and an edible ink indicium disposed on the film. In some embodiments, the arrangement may include a removable backing.

### BRIEF DESCRIPTION OF THE DRAWINGS

A better understanding of the embodiments will be obtained from a reading of the following detailed description and the accompanying drawings in which:

FIG. 1. A schematic showing the repeating unit structure of a chitosan polymer of an exemplary embodiment

FIG. 2. This is a photograph showing a pizza merged with an edible film of an exemplary embodiment.

FIG. 3. Is a photograph showing an exemplary edible film before (Panel A) and after (Panel B) contacting the film to a liquid (coffee).

### DETAILED DESCRIPTION

Embodiments include an edible plastic topper capable of receiving a food grade ink that will display selected imagery (e.g., the logo of The Ohio State University (OSU)). In an exemplary embodiment, this edible material may fuse into an edible media, for example, the cheese and or other toppings on top of an oven baked pizza. When an edible material of an exemplary embodiment is placed upon the edible media, the color of the printed topper will not substantially degrade due to the high baking temperature, nor will the edges of the material curl up. Instead, an exemplary material will melt and bond with the cheese or other toppings, fusing the edible indicium with the foodstuff. Because of its versatility, embodied methods may be used to decorate a wide variety of food and beverage items. Embodiments allow the final food product to appear as though the edible indicium was printed directly upon the food. Accordingly, various embodiments may enhance the market appeal of various foods that are heated before consumption.

Unless otherwise defined, all technical and scientific terms used herein have the same meaning as commonly understood by one of ordinary skill in the art to which these embodiments pertain. Although methods and materials similar or equivalent to those described herein can be used in the practice or testing of various embodiments, suitable methods and materials are described below. All publications, patent applications, patents, and other references mentioned herein are incorporated by reference in their entirety for all purposes. In case of conflict, the present specification, including definitions, will control. In addition, the materials, methods, and examples are illustrative only and not intended to be limiting.

The section headings used herein are for organizational purposes only and are not to be construed as limiting the described subject matter in any way. It will be appreciated that there is an implied “about” prior to metrics such as temperatures, concentrations, and times discussed in the present teachings, such that slight and insubstantial deviations are within the scope of the present teachings herein. In this application, the use of the singular includes the plural unless specifically stated otherwise. Also, the use of “comprise”, “comprises”, “comprising”, “contain”, “contains”, “containing”, “include”, “includes”, and “including” are not intended to be limiting. It is to be understood that both the foregoing general description and the following detailed description are exemplary and explanatory only and are not restrictive of the invention. The articles “a” and “an” are used herein to refer to one or to more than one (i.e., to at least one) of the grammatical object of the article. By way of example, “an element” means one element or more than one element.

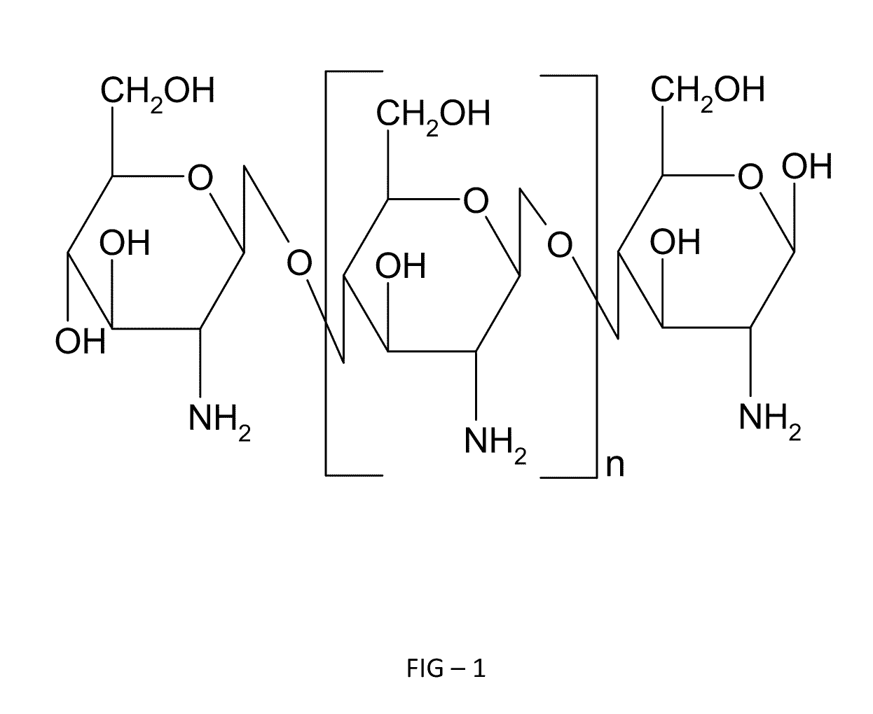

Chitosan is made from chitin, a polysaccharide found in the exoskeleton of many insects, crustaceans and the cell walls of various fungi. Chitosan is also known by the following names—chitosan ascorbate; deacetylated chitosan, enzymatic polychitosamine hydrolisat, hep-30; n-carboxybutyl chitosan; n,o-sulfated chitosan; o-sulfated n-acetylchitosan; sulfated n-carboxymethylchitosan; sulfated o-carboxymethylchitosan. Chitosan is made from chitin by adjusting the ration of the D-glucosamine units to the amino groups in the polymeric chain. This process is referred to as the degree of acetylation of the chitin. FIG. 1 shows the structure of chitosan. If the degree of acetylation of chitin is adjusted to a value approximating 0.5, chitosan will be formed.

The stiffness of the chitosan film is directly influenced by the content of the acetyl groups left on the chain after the synthesis process. This is so because of the higher degree of cross-linking that they cause with increasing acetylated concentration. With an increasing presence of the amino groups, cross-linking is reduced and more stretching of the chains results. This is caused by electrostatic repulsion between the amino groups on adjacent chains. The higher the concentration of these amino groups in the chain, the greater the degree of repulsion. This repulsion could be modulated by increasing the ionic strength (salt concentration) of the solution. Since the amino groups are susceptible to protonation in the presence of an acidic environment, the properties of the film could also be influenced by the pH of the solution. This ultimately affects the stiffness of the film when it is formed.

As a result of these competing forces within the chitosan polymeric chains, films with predetermined properties may be synthesized by the addition of selected chemical moieties to the starting raw materials. The nature of these additives may vary depending on the nature of the substrate to which the film will adhere, the desired shelf life of the product, the ability to quickly and cleanly cut the product/film, etc.

Because they offer the opportunity to heighten the aesthetic appeal of food, various embodiments may increase sales of particular food products. For example, if the food is intended for children, a favorite character may be printed onto a particular food prior to serving it. Similarly, embodiments may be useful for merging appealing indicium onto vitamins or other medications. Additionally, embodiments may be entertaining at social functions (birthday parties, weddings, etc.) and games such as football, basketball, etc., especially if a team logo is printed onto a relevant fare (e.g., pizza, hot-dogs, candies, cookies, buns and other types of bread, etc.)

Various embodiments include an edible plastic film for use as a food topper. In preferred embodiments, the plastic film comprises a chitosan polymer. In preferred embodiments, the films are formed in sheets having sufficient mechanical stability to allow them to be run through a printer, and or be adhered via a low-tack or another appropriate adhesive to an appropriate support or backing sheet that may be run through a printing or copying device. Embodiments also include films that may be wrapped onto a spool with or without the aid of a backing support.

The films of at least one exemplary arrangement include the ability to accept and retain food dye inks. The film of various embodiments will not allow the color of the ink to degrade within 30 days after printing at 23±2° C. and in 50%±2 RH storage condition.

The film of an exemplary embodiment can melt into the surface of baked foods, such as the cheese at the top of freshly baked pizza (or to any other food), without substantial curling of the edges or substantial changes in color.

Once merged to an edible media, the film of an exemplary embodiment does not significantly impede cutting of the edible media relative to an untreated food item.

The chitosan containing films of an exemplary embodiment have applications for use on many bakery products such as cookies, candies, chocolate bars, cakes, ice-cream cones, pies, bread and buns, etc. of different types. An exemplary embodiment may be adapted for use on prepared meats (e.g., SPAM®) and various other meat products that are packaged in different kinds of casings. The film of an exemplary embodiment could be used on sliced cheeses and other dairy products, baked potato, yams, and other root crops, cut fruits and vegetables. Advantageously, the film of an exemplary embodiment may even be used on liquids, foams, gels, creams, emulsions or other types of edible semisolids.

The embodiments described herein relate largely to edible foods. However, the invention is not so limited. The chitosan containing films of an exemplary embodiment may also be used on a wide variety of non-food applications. For example, the films may be useful to identify hospital patients by merging the films onto the arms and or legs of patients in hospitals, individuals at various ball games, table games, and other contact sports and during staged performances and movie events. In some cases, edible films made from starches, cellulose, proteins or lipids, or blending chitosan with any or all of these other types of edible films would be synthesized and used.

In an exemplary embodiment, the chitosan or chitosan derivative are combined with a water acid solution. Different concentrations of chitosan may be mixed with varying percentages of the acid (e.g., acetic acid) to give a chitosan solution of varying morphological compositions, gas permeabilities and mechanical properties. The viscosity of the solution may be influenced by the particle size (micro or nanoparticle) and molecular mass chitosan chosen to make the film. The higher the molecular mass of the chitosan, the higher the viscosity of the solution.

The properties of the films may be influenced by the addition of an appropriate plasticizer. Plasticizer may include various polyols such as glycerol, sorbitol, polyethylene glycol, glycerin, etc., or even sugars such as sucrose.

The chitosan may be dissolved at about 45° C. (in a water bath), preferably with constant mixing for about 10 to 15 minutes. Alternatively, this step may be performed at or about room temperature for 60 minutes. In various embodiments, this step may be performed at higher or lower temperatures, for shorter or longer time periods, respectively.

A 1% Tween-80 emulsifier may be added to the chitosan solution. The solution may then be further blended by ultrasonic mixing at approximately 45° C. for 10 to 15 minutes. As one of skill in the art will appreciate, the concentration of the emulsifier may be adjusted to one that is compatible with the quantities of other hydrophilic or hydrophobic additives that are included in the mixture. Other appropriate foodgrade emulsifiers such as lecithin for example could be used at a concentration commensurate with that of the other additives, solvents and chitosan percentage in the solution.

The chitosan film of an exemplary embodiment may include additives such as lipids, oils, fatty acids, waxes, or other polymers. Fatty acids may include stearic acid, lauric acid, plamitic acid, octanoic acid, butyric acid, methyl laurate, acetylated monoglycerides and propylene glycol monoesters, etc. The additives are capable of influencing the gas permeability of the chitosan film. The permeability and water holding capacity of the film could also be influenced by cross-linking the chitosan with a suitable organic compound such as 1,5-pentanodial (glutaraldehyde) for example. This also acts to increase the stiffness and tensile strength of the film. If it is necessary to improve the nutritional content of the film, vitamins or minerals such as calcium lactate, calcium gluconate, vitamin E (DL-tocopheryl), etc. may also be added. Flavor could be added to the film to complement the taste of the substrate. Flavors such as mint, cinnamon, sweet, vanilla as examples, could be incorporated into the film or applied to the surface as a coating.

If a colored film is desired, a 0.1% solution of an edible pigment (e.g., the edible pigment manufactured by India Tree, Inc., Seattle, Wash.) could be added to it at this point with mixing. Other appropriate coloring agents or blending of organic or inorganic compounds that produce coloring could be used to give a desired hue. As an example, to accomplish this, 100 μl aliquot of the pigment (manufactured by India Tree Inc. above) may be blended with a 20 ml portion of the 1% chitosan/1% tween-80 solution described below. This may be united with the remainder of the chitosan solution with mixing. The film could be produced with a transparent hue or translucent by using a dispersed coloring agent within the matrix of the film. Color could also be obtained by covering the surface of the film with a colored ink prior to or during the time of printing the logo.

The mixture may be cast into a greased or ungreased mould (made from plastic, metal, ceramic, wood, composite or flat glass) surface for the film formation or into another appropriate medium for resin formation. The cast solution may be dried at approximately 45° C. for 40 to 50 minutes. The film could also be dried at higher or lower temperatures but for shorter or longer time periods.

This rate of drying could be considerably decreased if the resin is extruded as a film or sheet. If a cast film is made, the thickness can be controlled by the rate of spreading, the quantity deposited or more accurately by the use of a controlled-thickness spreader. This thickness spreader has a product reservoir and an adjustable gate. If this is drawn over the receiving surface and the gate adjusted accordingly, a given rate of chitosan solution will flow and a film with uniform thickness could result.

The desired film thickness will be influenced by the temperature of the solution, its viscosity, the speed of the draw, the volume of solution falling from the gate and the dimensions of the gate and the receiving surface. The thickness of the film could also be controlled by the use of an appropriate coating rod, draw or roll-bar or by casting based on weight or volume control or any other suitable device for creating a uniformly thick film.

The film could then be affixed to a blank sheet of paper (or any other appropriate supporting material) with an appropriate low-tack adhesive before a given logo (or a selected design) is printed on to it. In various embodiments, the film possesses sufficient mechanical strength to be wrapped on a spool, cut into individual sheets or packaged in any suitable format prior to shipping and handling.

Various indicia (e.g., logos, characters, or other designs) may be printed on to the film using an edible ink. Edible inks are known and may be purchased from a commercial supplier. Preferably, these inks are made from an FDA approved food coloring. Various inks can be obtained in printer-ready cartridges (e.g., PhotoFrost edible inks, PhotoFrost Decorating Systems, Williston, Fla. 32696) that fit on most commercial printers (e.g., Hewlett-Packard, Epson, Canon, etc.).

Various other forms of printing may also be used to affix a logo to the film. These could be stamping, spraying, brushing, rolling, engraving, embossing, etching or other types of printing applied by mechanical, electronic or other methods. Logos could also be added to the film by adhesion of a preprinted edible label.

In at least one embodiment, the edible film comprising an edible indicium (e.g., school logo, text, picture, etc.) is sized to fit on the cheese topping of a baked pizza (or on that of any other substrate). While the pizza is still hot, the film is allowed to fuse into the cheese or other substrate.

If fusion is not uniformly achieved (due to abrupt cooling of the food, for example) the fusion may be completed by adding additional heat. For example, the edible media may be placed in a microwave, radio frequency, infra red, or any other type of convection or conduction oven and heated until complete fusion of the plastic into the cheese or other substrate is accomplished. Depending on the nature of the substrate, the chitosan may be blended with another edible polymer or polymers such as polysaccharides, lipids, proteins, etc.

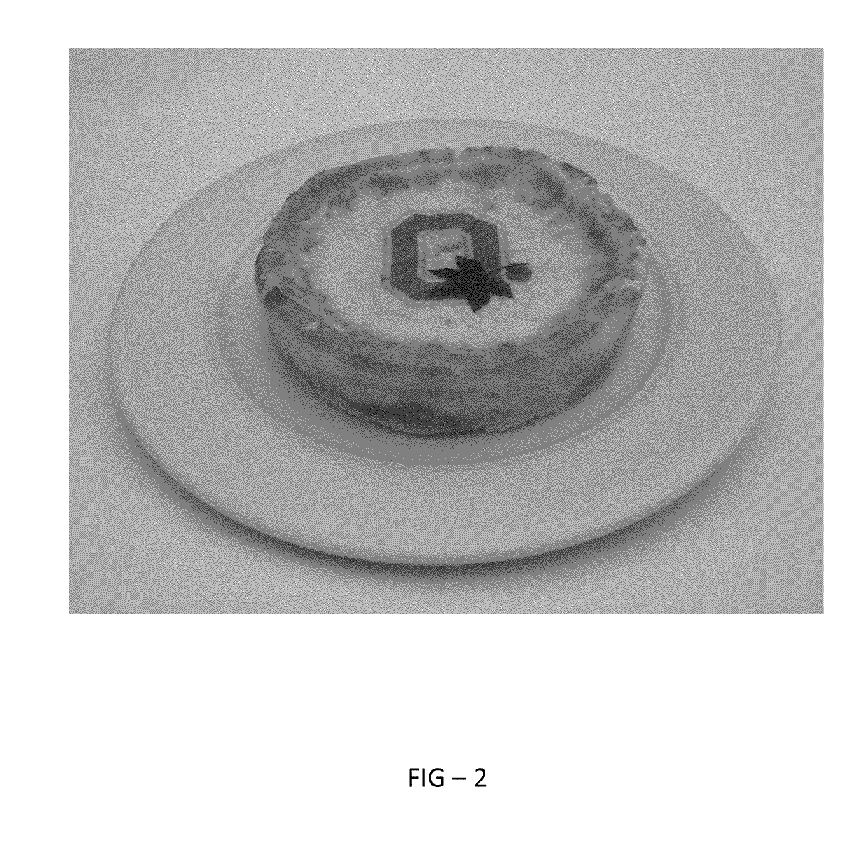

The film may or may not be discernable, depending on its color. However, the colored logo should be clearly visible and should give the appearance that the food item has been directly printed upon (see FIG. 2). In the case of a non-food item, the film could be affixed by the application of an appropriate heat, chemical, irradiation or mechanical source or adhesive.

Also provided are various kits for performing the methods provided herein. Additionally, the kit may include instructional materials for performing various methods presented herein. These instructions may be printed and/or may be supplied, without limitation, as an electronic-readable medium, such as a floppy disc, a CD-ROM, a DVD, a Zip disc, a video cassette, an audiotape, and a flash memory device. Alternatively, instructions may be published on an internet web site or may be distributed to the user as an electronic mail. When a kit is supplied, the different components can be packaged in separate containers. Such packaging of the components separately can permit long term storage without losing the active components' functions.

Although many edible films disclosed herein comprise chitosan and or chitosan derivatives, various embodiments and or component films may or may not include chitosan. Instead, specific embodiments comprise a mixture of protein, polysaccharide, and lipid fractions to form an edible film. The protein fractions could be from sources such as corn, soy, milk, gelatin, or other sources of proteins. Examples of polysaccharides could include hydroxypropyl methylcellulose, carrageenan, various gums, or starches from sources such as potato, rice, cassaya (Manihot esculenta), etc. The lipid fraction could be milk fat, various waxes such as candelilla, paraffin, carnauba or beeswax, various fatty acids such as stearic, palmitic or other types of lipids as examples.

### EXAMPLES

The following examples are included to demonstrate embodiments. It should be appreciated by those skilled in the art that the techniques disclosed in the examples which follow represent techniques discovered by the inventors to function well in practice. However, those of skill in the art should, in light of the present disclosure, appreciate that many changes can be made in the specific embodiments which are disclosed and still obtain a like or similar result without departing from the concept, spirit and scope of the invention. More specifically, it will be apparent that certain agents that are both chemically and physiologically related may be substituted for the agents described herein while the same or similar results would be achieved. All such similar substitutes and modifications apparent to those skilled in the art are deemed to be within the spirit, scope and concept of the invention.

### Example 1

### Preparation of an Edible Film with a

The following example demonstrates the preparation of an edible film used to decorate the pizza shown in FIG. 2. Initially, a 100 ml volume of a chitosan gel was prepared by combining a 1±0.1% chitosan (Sigma Chemicals) solution with a 1% acetic acid solvent.

The chitosan was then dissolved at about 45° C. (in a water bath), preferably with constant mixing for about 10 to 15 minutes. Next, a 1% Tween-80 emulsifier was added and the solution was further blended by ultrasonic mixed at approximately 45° C. for 10 to 15 minutes. The mixture was then cast into a greased mould surface for the film formation. It was then dried at approximately 45° C. for 40 to 50 minutes.

The film was then affixed to a blank sheet of paper possessing an appropriate low-tack adhesive before the image was printed on to it (see FIG. 2). The logo shown in FIG. 2 was printed on to the film using an FDA approved edible ink (PhotoFrost edible inks, PhotoFrost Decorating Systems, Williston, Fla. 32696) fit onto a commercial inkjet printer (e.g., Hewlett Packard Officejet 6500printer).

### Example 2

### Merging the Edible Film with the Edible Media

In the following example, the edible film created in Example 1 was merged onto a pizza. First, the film including the printed design was sized to fit on the cheese topping of a previously baked pizza. The printed film was applied to the pizza after it was removed from the oven, the residual heat from the pizza and the moisture (hot oils) from the cheese melted the topper onto the pizza. This heat caused the film to fuse into the pizza. As shown in FIG. 2, the printed design remained essentially unchanged.

### Example 3

### Synthesis of a Protein/Polysaccharide/Lipid Edible Film

Whey protein isolate (WPI), hydroxylpropyl methylcellulose (HPMC) and stearic acid were used for the protein, polysaccharide and lipid fractions, respectively. In this method, a batch of the film was produced by dissolving 12 g of WPI (4% wt/vol) in 283 g of distilled water and 5 g of glycerol. It began by adding the WPI to the water while slowly stirring. The addition of the glycerol was done subsequently with stiffing for 2 hours. The mixture was then heated to 90° C. for 30 minutes to allow the WPI to become denatured be stretching of their polymeric chains. The solution was then cooled in an ice bath to a temperature of 40° C. The pH of the solution was then adjusted to 7 using 2N NaOH. Depending on the quantity and quality of film required, the weight of WPI used to produce film could be increased or decreased. Glycerol acted as a plasticizer to the WPI and its effect could be modulated by adjusting its concentration to produce a film with varying properties as desired by the end user. Also, the pH of the solution could be adjusted to increase or decrease the ability of the protein to absorb amino acids onto its chains. This has the effect of making the structure more or less capable of acting as an emulsifier between the polysaccharide and the lipid fractions of the final film. This is so because pH affects the isoelectric point of the chemical species and thus their attraction to or repulsion from the whey protein.

A second solution was prepared by slowly adding 12 g of HPMC to 283 g of distilled water with overnight stirring at room temperature to produce a 4% wt/vol solution. This was then blended with the WPI solution mentioned above and the mixture stirred and heated to 80° C. While still hot, a 0.5% volume of (lipid) stearic acid solids (3 g) was added to the solution with stirring until dissolution was achieved. To increase the dispersion of the stearic acid throughout the solution, it was homogenized for 1 minute at 24,000 RPM and then for 2 minutes at 40,000 RPM at approximately 75° C. Coarse or fine homogenization could be chosen so long as they accomplish the goal of emulsifying the blend to the desired texture.

The solution was then allowed to cool to 40° C. in an ice bath after degassing using vacuum suction. Other methods of degassing could also be used including chemical defoaming, ultrasonication or other appropriate methods. The hydrophobic lipid fraction of the blend was designed to float on the hydrophilic beverage that was to be consumed and this acted as a cushion for the edible ink that was used to print the logo.

The concentrations of the HPMC and the stearic acid may be adjusted to produce films of varying qualities. The HPMC fraction helps to add mechanical strength to the film but it increases it ability to pick up moisture and dissolve when contacting the liquid beverage. If so desired, films could be made without the WPI fraction and only contain HPMC and stearic acid. Also, the WPI could be substituted for any other protein that would give a dairy free film with desired properties. These could include other proteins from milk, corn, wheat, soy, peanut, sunflower, sorghum, pistachio, egg white, fish, gelatin or other edible compounds. The emulsifying properties of the WPI could also be obtained from an edible substitute such as lecithin for example. The glycerol could also be substituted with other appropriate foodgrade compounds such as sorbitol or similar compounds for example. The stearic acid itself could be substituted with other lipids such as edible oils, milkfat, palmitic acid, or various types of waxes such as paraffin, candelilla, beeswax or carnauba for example. Depending on the chosen lipid, it could be added to the protein/polysaccharide by first dissolution is a small quantity of a food grade emulsifier. This would help to improve the blending of the lipid to the polysaccharide fractions. Depending on the substitution, the properties of the final film will vary. The method of blending the protein/polysaccharide/lipid fractions of the film could also be by other means such as lamination of each component. If this approach is taken, each component will be manufactured separately but bonded together using an appropriate method.

Although the film above used HPMC, other polysaccharides would also provide acceptable results. For example, various starches from potato, rice, corn or cassaya, cellulose from selected plant sources, chitinosan or glycogen from insect, crustacean or animal sources or even polysaccharides such as carrageenan could be possible substitutes. Some polysaccharides from microbial sources such as xanthan gum, dextran, or gellan, diutan and pullulan gums could be considered.

The films were then cast from the solution by pouring them into Teflon® circular dishes (moulds) then allowing overnight cooling to 35° C. The thicknesses of the films were adjusted by the weight of the solution poured into the circular dishes. The greater the weight of the solution the thicker the measurement of the films produced. The films were then removed and mounted onto a paper backing and printed as described for the chitosan film of Example 1. A film with an average thickness of 1 mil was used for decorating the coffee beverage (see Example 4 below).

The method of casting the film may vary depending on the available facilities and equipment. The dishes could be substituted with others made from wood, metal, glass or other types of plastic. The moulds could be greased or ungreased depending on the ease of releasing the final film after the drying period. The films could also be casted on to selected release paper backings or on to flat surfaces such as glass sheets for example.

### Example 4

### Applying an Edible Films to a Liquid Beverage

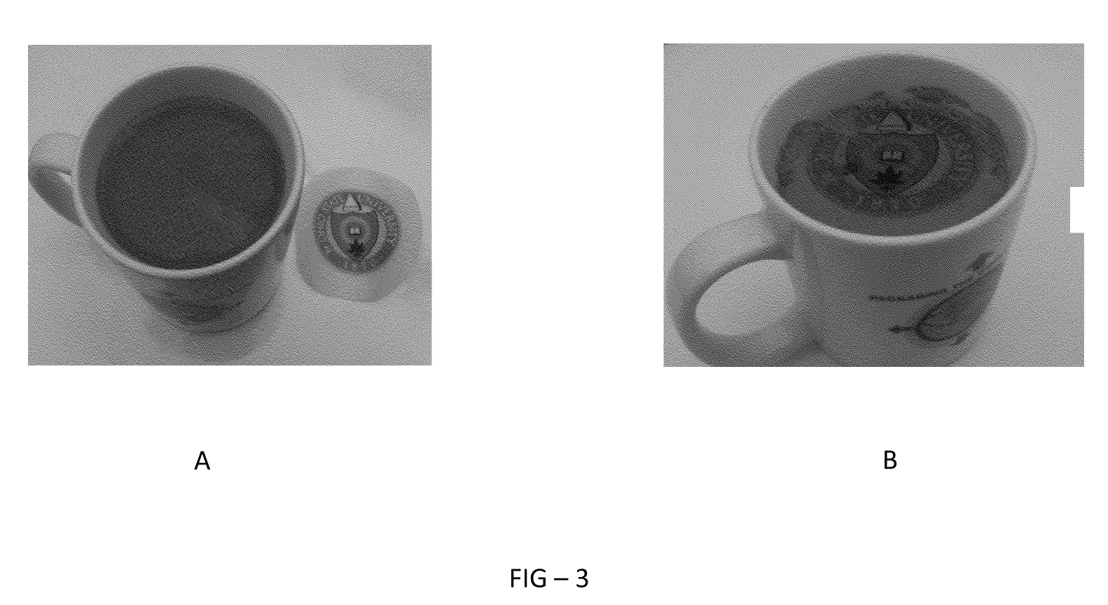

A mug of brewed liquid coffee at 68° C. was obtained from a dispenser. The printed film was cut to the diameter of the coffee in the mug. While still hot (60° C.), the film from Example 3 was deposited on to the surface of the liquid and allowed to float. As the coffee cooled to 55° C., the WPI/polysaccharide/lipid film slowly melted but the printed logo but remained afloat on the surface of the coffee. The logo remained clearly visible on the surface of the coffee for approximately 1 hour as shown in FIG. 3.

### Other Embodiments

It is to be understood that while embodiments have been described in conjunction with the description and examples above, the foregoing description and examples are intended to illustrate and not limit the scope of the invention. For example, foods with a predominantly protein, polysaccharide, lipid or blends of one or more of these combinations could be used as a substrate for attachment of an edible film. Depending on the chemical composition of the substrate, a film that is a polysaccharide, protein, lipid or blends of either or all of these to be the topper for the decoration may be selected. In some cases the substrate may be a solid, liquid, semi-solid, cream, gel, foam, emulsion or combinations of one or more of these. Many other aspects, advantages, and modifications are within the scope of the invention.

1. A method for printing an indicium onto an edible media, comprising:
obtaining an edible film comprising a chitosan polymer;
printing the indicium onto the film with an edible ink;
contacting the film to the edible media.

2. The method of claim 1, further comprising the step of heating the edible media before or after the contacting step.

3. The method of claim 1, further comprising the step of affixing the film onto a support material prior to the contacting step.

4. The method according to one of claim 1 or 3, wherein printing step is performed by ink jet, flexographic, laser, rotogravure, pad, relief or screen printing,

5. The method of claim 2, wherein the heating step is performed prior to contacting the film to the surface of the edible media.

6. The method of claim 1, wherein the indicium is a team logo.

7. The method of claim 1, wherein the indicium is a corporate trademark.

8. The method of claim 1, wherein the indicium is a color photograph.

9. The method of claim 1, wherein the edible media is a solid food.

10. The method of claim 9, wherein the solid food is selected from the group consisting of a pizza, a hotdog, a pancake, a candy, a pie, a cookie, a bread, a fruit, and a vegetable.

11. The method of claim 1, wherein the edible media is a liquid.

12. The method of claim 11, wherein the liquid is coffee, tea, beer or soft drink.

13. A method for preparing an edible film capable of adhering to the surface of a food, comprising;
combining chitosan with a water acid solution to form a chitosan solution;
mixing the chitosan solution with an emulsifier to form a casting solution;
placing the casting solution into a mould; and
drying the casting solution until an edible film is formed.

14. The method of claim 13, further comprising the step of affixing the film to a backing having a low-tack adhesive.

15. An arrangement for merging a decoration onto an edible media, comprising:
an edible film comprising a chitosan polymer; and
an edible ink indicium disposed on the film.

16. The arrangement according to claim 15, further comprising a removable backing.

17. The arrangement according to claim 16, wherein the backing is disposed on the opposite surface of the film relative to the indicium.

18. The arrangement according to claim 15, wherein the indicium is a team logo.

19. The method of claim 15, wherein the indicium is a color photograph.

20. An edible media produced by the method of claim 1.

21. The edible media according to claim 20, wherein the edible media is a solid food.

22. The edible media according to claim 20, wherein the edible media is a liquid.

23. A method for printing an indicium onto a liquid or semi-solid media, comprising:
obtaining an edible film comprising a blend of polysaccharides and lipids;
printing the indicium onto the film with an edible ink;
contacting the film to the edible media.

24. A method for printing an indicium onto a liquid or semi-solid media, comprising:
obtaining an edible film comprising a blend of protein and lipids;
printing the indicium onto the film with an edible ink;
contacting the film to the edible media.
